(19) United States
(12) Patent Application Publication
(10) Pub. No.: US 2011/0253305 A1
(43) Pub. Date: Oct. 20, 2011

(54) PACKAGE MANUFACTURING METHOD, PACKAGE, PIEZOELECTRIC VIBRATOR, OSCILLATOR, ELECTRONIC APPARATUS, AND RADIO TIMEPIECE

(76) Inventor: Yoichi FUNABIKI, Chiba-shi (JP)

(21) Appl. No.: 13/085,836

(22) Filed: Apr. 13, 2011

(30) Foreign Application Priority Data
Apr. 20, 2010 (JP) 2010-097346

(51) Int. Cl. B32B 38/04; B05D 5/12

(52) U.S. Cl. 156/252; 427/58

(57) ABSTRACT

A method of manufacturing a package in which generation of voids in the interior of glass frit is restrained, so that maintenance of hermeticity in a cavity and improvement of mechanical strength of through electrodes are achieved, such a package, a piezoelectric vibrator, an oscillator, an electronic apparatus, and a radio timepiece are provided. The invention is characterized by including baking glass frit filled in through holes and solidifying the same, and the baking step is performed by a decompressed atmosphere, which is set to a pressure lower than the atmospheric pressure.

### RELATED APPLICATIONS

This application claims priority under 35 U.S.C. §119 to Japanese Patent Application No. 2010-097346 filed on Apr. 20, 2010, the entire content of which is hereby incorporated by reference.

### BACKGROUND OF THE INVENTION

1. Field of the Invention

The present invention relates to a package manufacturing method, a package, a piezoelectric vibrator, an oscillator, an electronic apparatus, and a radio timepiece.

2. Description of the Related Art

In recent years, a piezoelectric vibrator (package) using crystal or the like as a time instance source, a timing source for control signals or the like, a reference signal source, and so on in mobile phone sets or portable digital assistant terminal devices. Various types of such piezoelectric vibrators are known, and a surface mount device (SMD) type piezoelectric vibrator is known as one of these piezoelectric vibrators. The piezoelectric vibrator of this type includes a base substrate and a lid substrate formed of, for example, glass material and joined to each other, and a cavity formed between these substrates, and a piezoelectric vibration reed (electronic component) stored in the cavity sealed in an air-tight manner.

In such a piezoelectric vibrator, through electrodes are formed in through holes formed in the base substrate, and the piezoelectric vibration reeds in the cavity and external electrodes out of the cavity are electrically connected via the through electrodes (for example, see JP-A-2002-124845) . More specifically, in JP-A-2002-124845, a method of forming the through holes in the base substrate, and driving metallic pins into the through holes in a state in which the base substrate is heat-softened is described. However, in this method, it is difficult to close gaps between the metallic pins and the through holes completely, and hence the hermeticity in the cavity cannot be secured disadvantageously. In addition, it is troublesome to position the metallic pins in all the through holes on the base substrate and drive these metallic pins into these through holes.

Therefore, recently, a technique to fill glass frit into the gap between the through hole and the metallic pin and bake the glass frit to integrate the base substrate and the metallic pin is developed.

In this case, as shown in FIG. 15A, first of all, a core portion 202 of a rivet type metallic pin 203 having a flat plate-shaped base portion 201 and the core portion 202 extending upright from a surface of the base portion 201 along a normal line is inserted into a through hole 205 in the base substrate 204. Subsequently, as shown in FIG. 15B, after having filled paste-state glass frit 206 into a gap between the through hole 205 and the core portion 202, the filled glass frit 206 is baked. Accordingly, as shown in FIG. 15C, a glass member 207 formed by baking the glass frit 206 and the base substrate 204 (the through hole 205) and the metallic pin 203 are integrated. Then, by grinding the base substrate 204 to a broken line H and removing the base portion 201, a through electrode 210 is formed. Therefore, it is considered that the through hole 205 can be closed and hence stable conductivity between the piezoelectric vibration reed and the external electrode can be secured.

When baking the glass frit 206, the glass frit 206 filled in the interior of the through hole 205 is increased in temperature from the outside, so that baking is gradually proceeded from the outside of the glass frit 206 (the opening side of the through hole 205) inward.

In this case, since the glass frit 206 on the outside after the completion of baking acts as a lid, gas generated when binder contained in the glass frit 206 evaporates (for example, CO₂ or H₂O, etc.) or air or the like entrapped among glass particles in the glass frit 206 can hardly be discharged to the outside of the glass frit 206 disadvantageously.

Then, the gas or the air which are not discharged at the time of baking remains in the glass frit 206 in the form of relatively large air bubbles, and forms voids 211 in the glass member 207 after the completion of baking as shown in FIG. 16A. Consequently, there are risks of lowering of adhesion between the through hole 205 and the core portion 202 with respect to the glass member 207 and impairment of the hermeticity in the cavity of the piezoelectric vibrator. As shown in FIG. 16B, when the base substrate 204 is ground after the baking and the through electrode 210 is formed, there are risks of generation of depression 212 on a front surface of the base substrate 204 because the voids 211 are exposed therefrom and, in worse cases, the through hole 205 may be opened. In this case, there are not only a possibility of impairment of the air-tightness in the cavity, but also a possibility of breakage of an electrode film or the like formed so as to cover the depression 212 after the formation of the through electrode 210 which may lead to impairment of electric conductivity between the piezoelectric vibration reed and the electrode film.

In addition, the mechanical strength of the through electrode 210 may be lowered disadvantageously due to the lowering of the adhesion of the glass member 207 with respect to the through hole 205 and the core portion 202. Then, the lowering of the mechanical strength of the through electrode 210 may disadvantageously lead to the lowering of the mechanical strength of the piezoelectric vibrator.

### SUMMARY OF THE INVENTION

In view of such circumstances, it is an object of the invention to provide a method of manufacturing a package in which generation of voids in the interior of glass frit is restrained, so that maintenance of hermeticity in a cavity and improvement of mechanical strength of through electrodes are achieved, such a package, a piezoelectric vibrator, an oscillator, an electronic apparatus, and a radio timepiece.

In order to solve the above-described problems and achieve the object described above, the invention provides a package manufacturing method which is capable of sealing an electronic component in a cavity formed among a plurality of substrates bonded to each other, including a through electrode forming step for forming a through electrode which penetrates through a first substrate of the plurality of substrates in the direction of thickness thereof and brings the inside of the cavity and the outside of the plurality of substrates into conduction, wherein the through electrode forming step includes a depressed portion forming step for forming a depressed portion on a first surface of the first substrate, a metallic pin arranging step for inserting a metallic pin into the depressed portion, a filling step for filling a glass frit between the depressed portion and the metallic pin, a baking step for baking and solidifying the glass frit filled in the depression, and a grinding step for grinding at least a second surface of the first substrate to expose the metallic pin from the second surface, and the baking step is performed under a decompressed atmosphere set to a pressure lower than the atmospheric pressure.

In this configuration, by performing the baking step under the decompressed atmosphere set to be lower than the atmospheric pressure, since the glass frit can be baked while degassing, the air bubbles, if they are remained in the glass fit, can be removed at the time of baking. Accordingly, formation of voids in the glass is restrained, and solid glass can be formed between the depressed portion and the metallic pin. Therefore, the hermeticity in the cavity can be maintained. Since the formation of a depression due to the voids on the glass after the grinding step can be restrained, occurrence of breakage of an electrode film formed so as to cover the through electrode is restrained, and hence conductivity between the inside and the outside of the cavity is secured.

Since the solid glass can be formed between the depressed portion and the metallic pin, the adhesion of the depressed portion and the metallic pin with respect to the glass is improved, and hence the mechanical strength of the through electrode can be improved. Consequently, the mechanical strength of the package can be improved.

Preferably, the filling step is performed using a vacuum printing method.

In this configuration, by filling with the glass frit using the vacuum printing method, the glass frit is degassed, and hence air bubbles (air or the like) contained in the glass flit can be removed. Accordingly, the depressed portion may be filled with the glass frit having less air bubbles.

Since the glass frit is filled in a state in which the interior of the depressed portion is degassed, the depressed portion can be filled smoothly with the glass frit in comparison with a case of filling the glass frit under an atmospheric pressure atmosphere. Consequently, the depressed portion can be filled with the glass frit without forming gap.

Then, by baking the glass frit in this state, the depressed portion can be sealed without the gap, the adhesion between the depressed portion and the metallic pin with respect to the glass is further improved, and the maintenance of the hermeticity in the cavity and the mechanical strength of the through electrode can be improved.

Preferably, a provisionally drying step for removing solvent contained in the glass frit is provided between the filling step and the baking step, and in the provisionally drying step, the solvent is evaporated at a temperature higher than the boiling point of the solvent and lower than the melting point of the glass particles contained in the glass frit.

In this configuration, in the provisionally drying step, the glass particles of the glass frit do not melt, and hence the voids are present among the glass particles. Therefore, gas generated by evaporation of the solvent flows in the voids among the glass particles and is discharged out from the glass frit. In this manner, since the solvent can be removed effectively before the baking step, such gas to be generated by evaporation of the solvent in the baking step can be restrained.

Preferably, a binder removing step for removing binder contained in the glass frit is provided between the filling step and the baking step, and in the binder removing step, the binder is evaporated at a temperature higher than the boiling point of the binder and lower than the melting point of the glass particles contained in the glass frit.

In this configuration, since the binder can be evaporated without melting the glass particle, gas generated by the evaporation of the binder flows through the voids among the glass particles and is discharged efficiently to the outside of the glass frit. In this manner, since the binder can be removed effectively before the baking step, such gas to be generated by evaporation of the binder in the baking step can be restrained.

A package according to the invention is manufactured by using the method of manufacturing the package according to the invention.

In this configuration, since the package is manufactured by using the package manufacturing method according to the invention, a package superior in hermeticity in the cavity and superior in conductivity between the inside and the outside of the cavity is provided. In addition, the package secured in the mechanical strength can be provided.

Preferably, the piezoelectric vibrator according to the invention includes a piezoelectric vibration reed sealed in the cavity of the package of the invention in an air-tight manner.

In this configuration, since the package superior in hermeticity according to the invention is provided, the piezoelectric vibrator superior in vibrating properties can be provided. Also, the piezoelectric vibrator superior in conductivity between the inside and the outside of the cavity can also be provided. In addition, the piezoelectric vibrator secured in the mechanical strength can be provided.

An oscillator according to the invention includes the piezoelectric vibrator according to the invention electrically connected to an integrated circuit as an oscillation element.

An electronic apparatus according to the invention includes the piezoelectric vibrator according to the invention electrically connected to a clocking unit.

A radio timepiece according to the invention includes the piezoelectric vibrator according to the invention electrically connected to a filter unit.

In the oscillator, the electronic apparatus, and the radio timepiece according to the invention, since the piezoelectric vibrator according to the invention is provided, a product superior in characteristics and reliability can be provided.

According to the package manufacturing method and the package according to the invention, since the formation of the voids in the glass can be restrained, a package superior in hermeticity in the cavity and superior in conductivity between the inside and the outside of the cavity can be provided. Also, since the mechanical strength of the through electrode can be improved, a package superior in mechanical strength can be provided.

According to the piezoelectric vibrator in the invention, since the package superior in hermeticity according to the invention is provided, the piezoelectric vibrator superior in vibrating properties can be provided. Also, the piezoelectric vibrator superior in conductivity between the inside and the outside of the cavity can also be provided. In addition, the piezoelectric vibrator secured in mechanical strength can be provided.

In the oscillator, the electronic apparatus, and the radio timepiece of the invention described above, since the piezoelectric vibrator according to the invention is provided, a product superior in characteristics and reliability can be provided.

### BRIEF DESCRIPTION OF THE DRAWINGS

FIG. 1 is an appearance perspective view of a piezoelectric vibrator in an embodiment of the invention;

FIG. 2 is a drawing showing an internal configuration of the piezoelectric vibrator shown in FIG. 1 and is a drawing of a piezoelectric vibration reed viewed from above in a state in which a lid substrate is removed;

FIG. 3 is a cross-sectional view of the piezoelectric vibrator taken along a line A-A in FIG. 2;

FIG. 4 is an exploded perspective view of the piezoelectric vibrator shown in FIG. 1;

FIG. 5 is a flowchart showing a method of manufacturing the piezoelectric vibrator;

FIG. 6 is a process drawing for explaining the method of manufacturing the piezoelectric vibrator, and is an exploded perspective view of a bonded wafer member;

FIG. 7A is a cross-sectional view of a base substrate wafer and is a process drawing for explaining a through hole forming step;

FIG. 7B is a cross-sectional view of the base substrate wafer and is a process drawing for explaining a metallic pin arranging step;

FIG. 8 is a perspective view of the metallic pin;

FIGS. 9A to 9D are cross-sectional views of the base substrate wafer and are process drawings for explaining a filling step;

FIGS. 10A to 10C are cross-sectional views of the base substrate wafer and are process drawings for explaining steps from a provisional drying step onward;

FIGS. 11A and 11B are cross-sectional views of the base substrate wafer and are process drawings for explaining a grinding step;

FIG. 12 is a drawing showing an embodiment of the invention, and is a drawing showing a configuration of an oscillator;

FIG. 13 is a drawing showing a configuration of an electronic apparatus according to an embodiment of the invention;

FIG. 14 is a drawing showing a configuration of a radio timepiece according to an embodiment of the invention;

FIGS. 15A to 15C are cross-sectional views of the base substrate and are process drawings for explaining a method of forming a through electrode in the related art; and

FIGS. 16A and 16B are cross-sectional views of the base substrate in the related art.

### DETAILED DESCRIPTION OF THE PREFERRED EMBODIMENTS

Referring now to the drawings, an embodiment of the invention will be described.

### (Piezoelectric Vibrator)

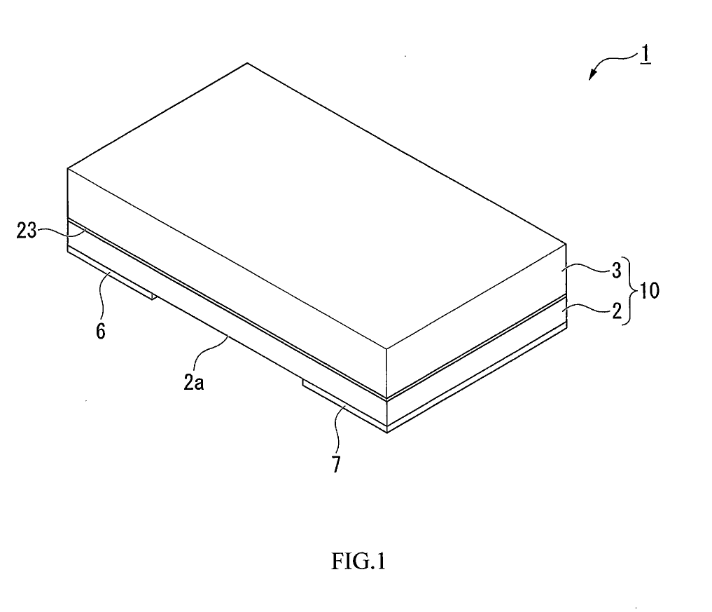

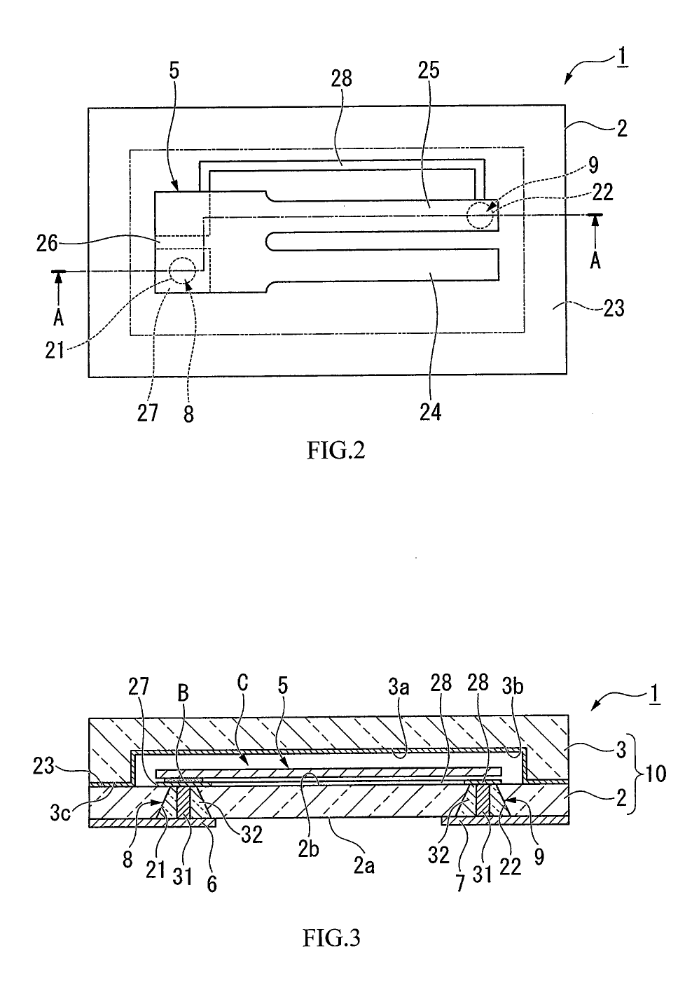

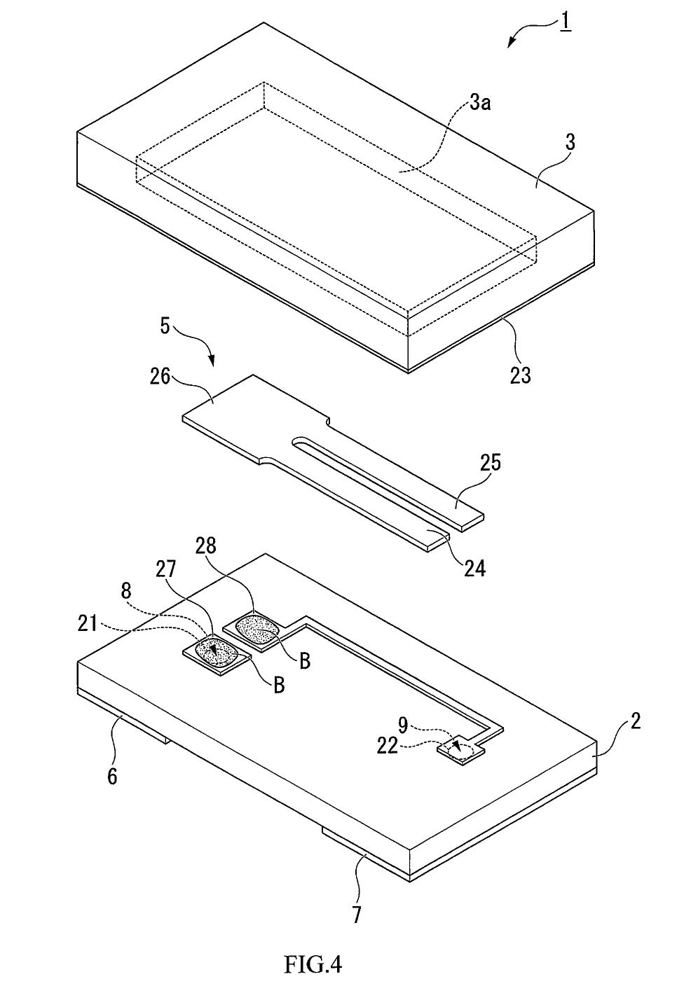

FIG. 1 is an appearance perspective view of a piezoelectric vibrator according to the embodiment viewed from the side of a lid substrate. FIG. 2 is a drawing showing an internal configuration of the piezoelectric vibrator showing a piezoelectric vibration reed viewed from above in a state in which the lid substrate is removed. FIG. 3 is a cross-sectional view of the piezoelectric vibrator taken along a line A-A in FIG. 2. FIG. 4 is an exploded perspective view of the piezoelectric vibrator.

As shown in FIG. 1 to FIG. 4, a piezoelectric vibrator 1 according to this embodiment is the surface mount device-type piezoelectric vibrator 1 having a box-shaped package 10 having a base substrate (first substrate) 2 and a lid substrate 3 formed by anodic wafer bonding via a bonding material 23, and a piezoelectric vibration reed (electronic component) 5 stored in a cavity C of the package 10. Then, the piezoelectric vibration reed 5 and external electrodes 6 and 7 installed on a back surface 2a of the base substrate 2 (a lower surface in FIG. 3: a first surface) are electrically connected via a pair of through electrodes 8 and 9 penetrating through the base substrate 2.

The base substrate 2 is a transparent insulating substrate formed of a glass material, for example, soda lime glass, and is formed into a plate-shape. The base substrate 2 is formed of a pair of through holes (depressions) 21 and 22 formed with the pair of through electrodes 8 and 9. The through holes 21 and 22 have a tapered shape in cross-section gradually reduced in diameter from the back surface 2a toward a front surface 2b (an upper surface in FIG. 3) of the base substrate 2.

The lid substrate 3 is a transparent insulating substrate formed of a glass material, for example, soda lime glass in the same manner as the base substrate 2, and is formed into a plate shape having a size which can be overlapped with the base substrate 2. Then, a rectangular shaped depressed portion 3a for storing the piezoelectric vibration reed 5 is formed on the side of an inner surface 3b (the lower surface in FIG. 3) of the lid substrate 3. The depressed portion 3a defines the cavity C for storing the piezoelectric vibration reed 5 when the base substrate 2 and the lid substrate 3 are placed on top of another. Then, the lid substrate 3 is bonded to the base substrate 2 via the bonding material 23 by anodic wafer bonding in a state in which the depressed portion 3a is opposed to the base substrate 2. In other words, on the side of the inner surface 3b, the lid substrate 3 includes a depressed portion 3a formed at a center thereof and a frame area 3c which is formed around the depressed portion 3a and corresponds to a bonded surface with respect to the base substrate 2.

The piezoelectric vibration reed 5 is a vibration reed having a tuning fork shape formed of piezoelectric material such as crystal, lithium tantalite, or lithium niobate and is configured to vibrate when a predetermined voltage is applied thereto.

The piezoelectric vibration reed 5 has the tuning fork shape including: a pair of vibrating arm portions 24 and 25 arranged in parallel and a base portion 26 configured to integrally fix proximal sides of the pair of vibrating arm portions 24 and 25, and the pair of vibrating arm portions 24 and 25 have an exciting electrode having a pair of first and second exciting electrodes, not shown, for vibrating the vibrating arm portions 24 and 25 and a pair of mount electrodes configured to electrically connect the first exciting electrode and the second exciting electrode with drawing electrodes 27 and 28 on outer surfaces of the pair thereof (both not shown).

The piezoelectric vibration reed 5 configured in this manner is bonded by bump bonding onto the drawing electrodes 27 and 28 formed on the front surface 2b of the base substrate 2 while utilizing a bump B such as gold, as shown in FIGS. 2 and 3. More specifically, the first exciting electrode of the piezoelectric vibration reed 5 is bonded by bump bonding onto the drawing electrode 27 via one of the mount electrode and the bump B, and the second exciting electrode is bonded by bump bonding onto the other drawing electrode 28 via the other mount electrode and the bump B. Accordingly, the piezoelectric vibration reed 5 is supported in a state of being lifted from the front surface 2b of the base substrate 2, and a state in which the respective mount electrodes and the drawing electrodes 27 and 28 are electrically connected respectively is achieved.

The external electrodes 6 and 7 are arranged on the both sides on the back surface 2a of the base substrate 2 in the longitudinal direction, and are electrically connected to the piezoelectric vibration reed 5 via the respective through electrodes 8 and 9 and the drawing electrodes 27 and 28. More specifically, the external electrode 6 is electrically connected to a mount electrode of the piezoelectric vibration reed 5 via the through electrode 8 and the drawing electrode 27. The other external electrode 7 is electrically connected to the other mount electrode of the piezoelectric vibration reed 5 via the other through electrode 9 and the drawing electrode 28.

The through electrodes 8 and 9 are made up of a cylindrical member 32 and a core member 31 fixed integrally to the through holes 21 and 22 by baking, and have a role to maintain the hermeticity in the cavity C by completely closing the through holes 21 and 22, and bring the external electrodes 6 and 7 into conduction with the drawing electrodes 27 and 28. More specifically, the through electrode 8 is positioned downward of the drawing electrode 27 between the external electrode 6 and the base member 26, and the other through electrode 9 is positioned between the external electrode 7 and the vibrating arm portion 25 downward of the drawing electrode 28.

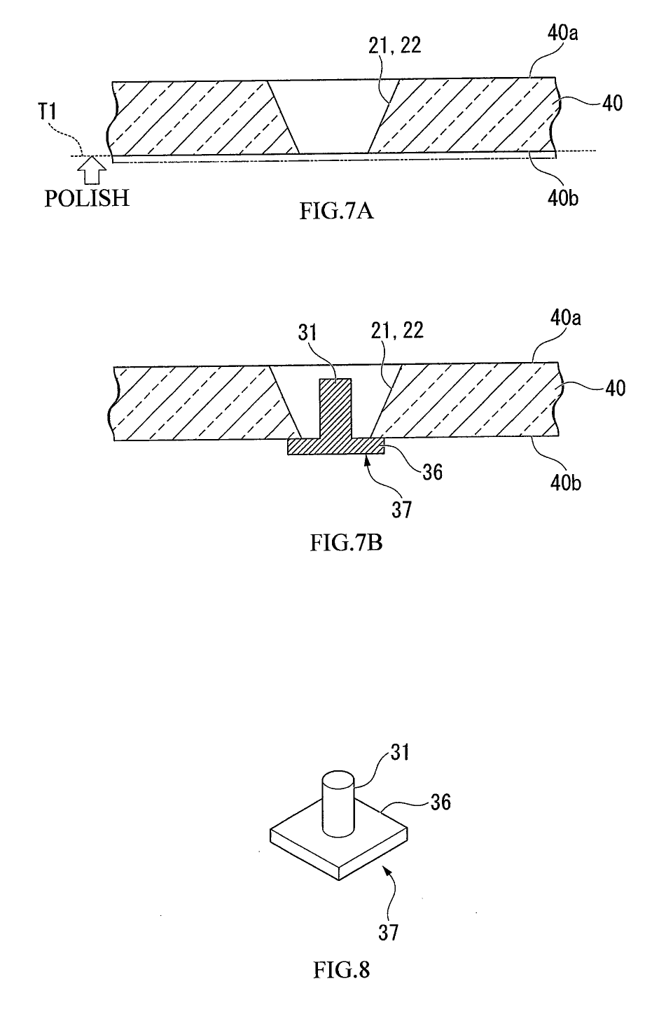

The cylindrical member 32 is a member formed by baking a paste-like glass frit 38 (see FIG. 7). The cylindrical member 32 is formed into a cylindrical shape being flat at both ends thereof and having the substantially same thickness as the base substrate 2. Then, the core member 31 is arranged at a center of the cylindrical member 32 so as to penetrate through a center hole of the cylindrical member 32. In this embodiment, an outline of the cylindrical member 32 is formed into a truncated conical shape (tapered in cross section) so as to fit the shape of the through holes 21 and 22. Then, the cylindrical members 32 are baked in a state of being embedded in the through holes 21 and 22, and are firmly secured to the through holes 21 and 22.

The above-described core member 31 is a conductive core member formed of a metallic material into a cylindrical shape, and is formed to be flat on both ends thereof in the same manner as the cylindrical member 32 and having the substantially same thickness as the base substrate 2. When the through electrodes 8 and 9 are formed as completed members, the core member 31 is formed to have the cylindrical shape and the same thickness as the thickness of the base substrate 2 as described above. In contrast, in the manufacturing step, a rivet-shaped metallic pin 37 is formed together with a flat plate-shaped base member 36 connected to one end of the core member 31 as shown in FIG. 8, described later.

The bonding material 23 for anodic wafer bonding is formed over the entire inner surface 3b of the lid substrate 3. More specifically, the bonding material 23 is formed over the entire inner surface of the frame area 3c and the depressed portion 3a. The bonding material 23 in this embodiment is formed of an Si film. However, the bonding material 23 may be formed of Al instead. The bonding material may be formed of an Si bulk material reduced in resistance by doping or the like. As described later, the bonding material 23 and the base substrate 2 are bonded by anodic wafer bonding, and the cavity C is vacuum-sealed.

When activating the piezoelectric vibrator 1 configured in this manner, a predetermined drive voltage is applied to the external electrodes 6 and 7 formed on the base substrate 2. Accordingly, an electric current can be flowed to the respective exciting electrodes of the piezoelectric vibration reed 5, so that the pair of vibrating arm portions 24 and 25 can be vibrated at a predetermined frequency in the direction toward and apart from each other. Then, the vibration of the pair of vibrating arm portions 24, 25 can be used as the time instance source, the timing source of the control signal, the reference signal source, and so on.

### (Method of Manufacturing Piezoelectric Vibrator)

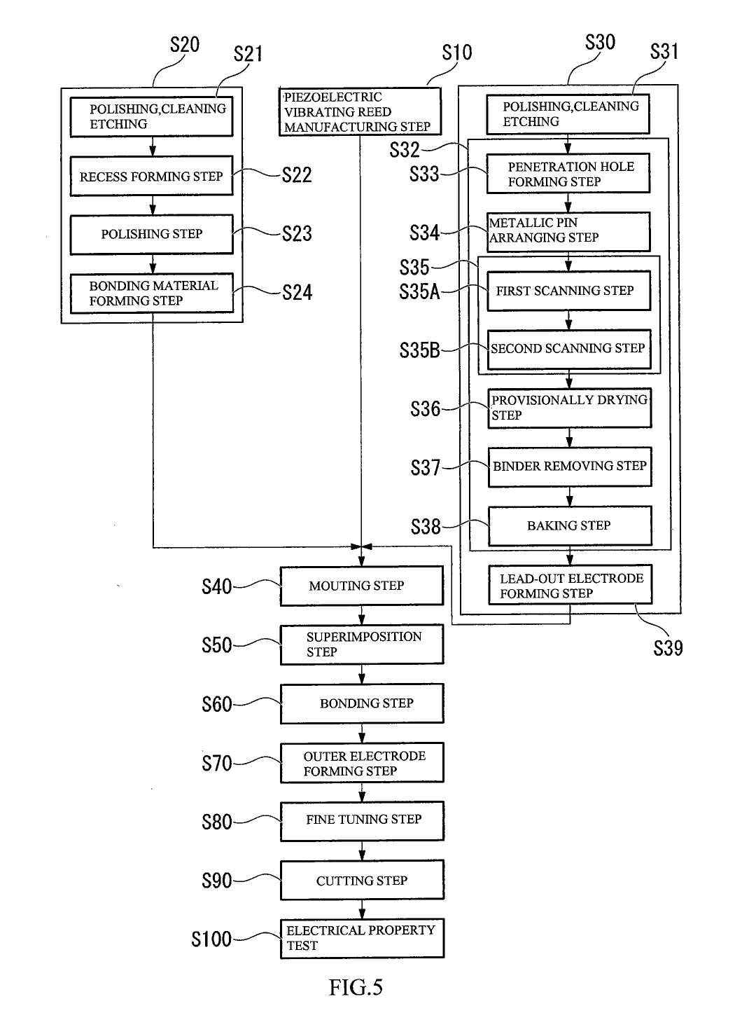

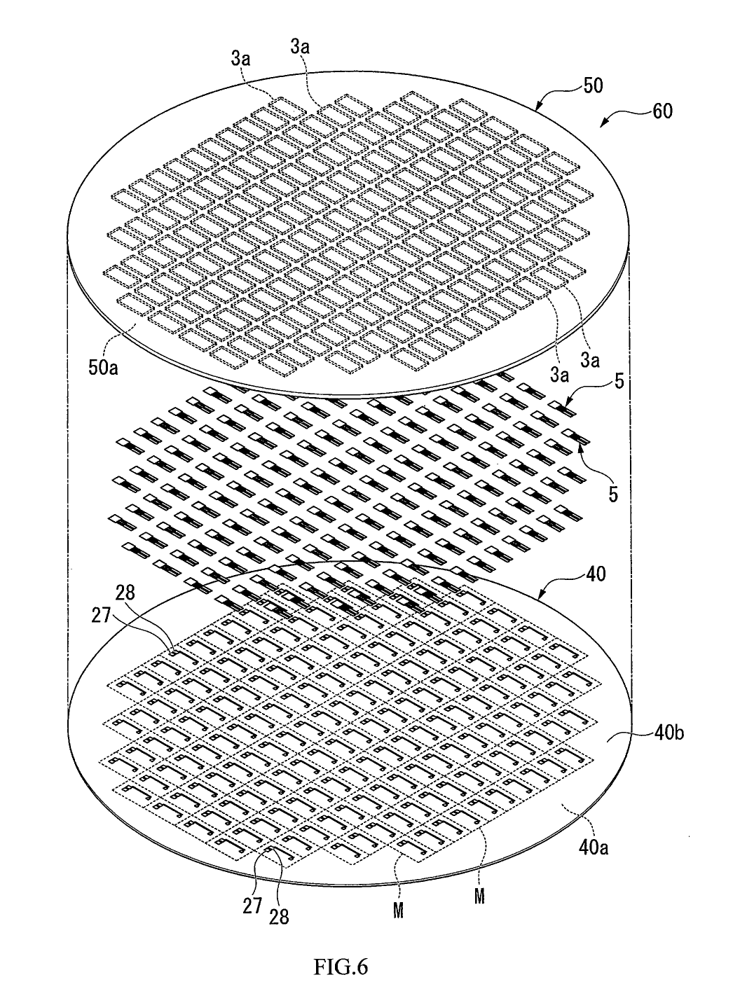

Subsequently, a method of manufacturing the above-described piezoelectric vibrator will be described. FIG. 5 is a flowchart showing a method of manufacturing the piezoelectric vibrator according to this embodiment. FIG. 6 is an exploded perspective view of a bonded wafer member. Described below is a method of manufacturing a plurality of piezoelectric vibrators 1 simultaneously by placing a plurality of the piezoelectric vibration reeds 5 between a base substrate wafer 40 having a plurality of the base substrates 2 arranged continuously thereon and a lid substrate wafer 50 having a plurality of the lid substrates 3 arranged continuously thereon in a sealed manner to form a bonded wafer member 60, and cutting the bonded wafer member 60 into pieces. Broke lines M shown in FIG. 6 are cutting lines to be cut in a cutting step.

As shown in FIG. 5, a method of manufacturing the piezoelectric vibrator according to this embodiment mainly includes a piezoelectric vibration reed fabricating step (S10), a lid substrate wafer fabricating step (S20), a base substrate wafer fabricating step (S30), and an assembling step (from S40 onward). From among these steps, the piezoelectric vibration reed fabricating step (S10), the lid substrate wafer fabricating step (S20), and the base substrate wafer fabricating step (S30) can be performed simultaneously.

First of all, the piezoelectric vibration reed fabricating step is performed to fabricate the piezoelectric vibration reed 5 shown in FIG. 1 to FIG. 4 (S10). After having fabricated the piezoelectric vibration reed 5, a coarse adjustment of resonance frequency is performed. Fine adjustment for adjusting the resonance frequency with higher degree of accuracy is performed after having mounted.

(Lid Substrate Wafer Fabricating Step)

Subsequently, as shown in FIG. 5 and FIG. 6, the lid substrate wafer fabricating step (S20) for fabricating the lid substrate wafer 50 which becomes the lid substrate 3 to a state immediately before anodic wafer bonding is performed. More specifically, after having grinded the soda lime glass to a predetermined thickness and washed the same, a lid substrate wafer 50 of a disc shape having the affected layer on the topmost surface thereof removed by etching or the like is formed (S21). Subsequently, a depressed portion forming step (S22) which forms the plurality of depressed portions 3a for cavity C in the direction of arrangement of rows by etching or the like on a first surface 50a of the lid substrate wafer 50 (lower surface in FIG. 6) is performed.

Subsequently, in order to secure the hermeticity with respect to the base substrate wafer 40 described later, a grinding step (S23) for grinding at least the first surface 50a side of the lid substrate wafer 50, which corresponds to a bonded surface with respect to the base substrate wafer 40 is performed to polish the first surface 50a into a mirror-smooth state.

Subsequently, a bonding material forming step (S24) for forming the bonding material 23 entirely over the first surface 50a of the lid substrate wafer 50 (the bonded surface with respect to the base substrate wafer 40 and the inner surface of the depressed portion 3a) is performed. In this manner, by forming the bonding material 23 entirely over the first surface 50a of the lid substrate wafer 50, the patterning of the bonding material 23 is no longer needed, and hence reduction of the manufacturing cost is achieved. Formation of the bonding material 23 is achieved by a film forming method such as spattering or chemical-vapor deposition (CVD). Since the bonded surface is ground before the bonding material forming step (S24), the flatness of the surface of the bonding material 23 is secured, and stable bonding with respect to the base substrate wafer 40 is achieved.

With the procedure as described above, the lid substrate wafer fabricating step (S20) is ended.

### (Base Substrate Wafer Fabricating Step)

Subsequently, simultaneously with or a timing before or after the steps described above, a base substrate wafer fabricating step (S30) configured to fabricate the base substrate wafer 40 which becomes the base substrate 2 later to a state immediately before performing the anodic wafer bonding is performed. First of all, after having grinded the soda lime glass to a predetermined thickness and washed the same, the base substrate wafer 40 of a disc shape having the affected layer on the topmost surface thereof removed by etching or the like is formed (S31).

### (Through Electrode Forming Step)

Subsequently, a through electrode forming step (S32) for forming the through electrodes 8 and 9 (see FIG. 3) which penetrate through the base substrate wafer 40 in the direction of thickness thereof bring the inside of the cavity C and the outside of the piezoelectric vibrator 1 into conduction is performed. The detailed description about the through electrode forming step (S32) will be given below. FIG. 7A and 7B are cross-sectional views of a base substrate wafer and a process drawing for explaining the through hole forming step and a metallic pin arranging step, respectively.

In the through electrode forming step (S32), as shown in FIG. 7A, first of all, a through hole forming step (S33: depressed portion forming step) for forming a plurality of the pairs of through holes 21 and 22 penetrating through the base substrate wafer 40 is performed. More specifically, depressed portions are formed from a first surface 40a of the base substrate wafer 40 by pressing or the like, and then, the base substrate wafer 40 is ground from a second surface 40b side thereof to a broken line T1, so that the depressed portions are penetrated and hence the through holes 21 and 22 can be formed. Accordingly, the through holes 21 and 22 can be formed so as to increase the inner diameter gradually from the second surface 40b side toward the first surface 40a side of the base substrate wafer 40 (base substrate 2).

Subsequently, the metallic pin arranging step (S34) for arranging the core members 31 of the metallic pins into the plurality of through holes 21 and 22 formed in the through electrode forming step (S32) is performed. FIG. 8 is a perspective view of the metallic pin.

As shown in FIG. 8, the metallic pin 37 includes the flat panel-shaped base member 36, and the core member 31 formed on the base member 36 along a direction substantially orthogonal to the surface of the base member 36 so as to have a length slightly shorter than the thickness of the base substrate wafer 40 and have a flattened distal end.

Then, when inserting the core members 31 of the metallic pins 37 each from the small-diameter side (the side of the second surface 40b of the base substrate wafer 40) of the through holes 21 and 22 as shown in FIG. 7B, the core members 31 each are inserted until the surface of the base member 36 of the above-described metallic pin 37 comes into contact with the second surface 40b of the base substrate wafer 40. Here, it is required to arrange the metallic pins 37 so that axial directions of the core members 31 and the axial directions of the through holes 21 and 22 substantially match. However, since the metallic pins 37 each having the core member 31 formed on the base member 36 are used, the axial directions of the core members 31 and the axial direction of the through holes 21 and 22 can be substantially matched by a simple operation of pushing the base member 36 until it comes into contact with the base substrate wafer 40. Therefore, the operability in the metallic pin arranging step (S34) can be improved.

### (Filling Step)

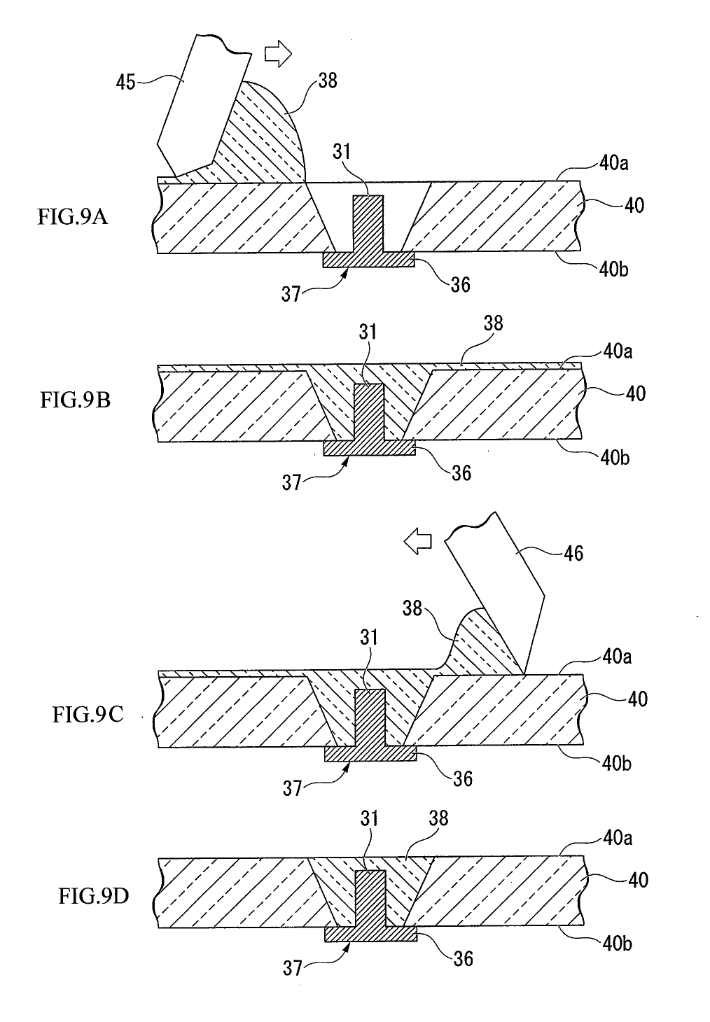

FIGS. 9A to 9B are cross-sectional views of the base substrate wafer and are process drawings for explaining a filling step.

As shown in FIG. 9A, a filling step (S35) for transporting the base substrate wafer 40 in which the metallic pins 37 are set into a vacuum printing apparatus, and filling the paste-state glass frit 38 into the through holes 21 and 22 is performed. In the filling step (S35) in this embodiment, the glass frit 38 is filled from the large-diameter side (the side of the first surface 40a of the base substrate wafer 40) of the through holes 21 and 22 by scanning squeegees (a first squeegee 45 and a second squeegee 46) along the first surface 40a of the base substrate wafer 40 in a chamber, not shown, of the vacuum printing apparatus. The vacuum printing apparatus in this embodiment includes a jig, not shown, for holding the base substrate wafer 40, and the first squeegee 45 (see FIG. 9A) and the second squeegee 46 (see FIG. 9C) held by a movable mechanism, not shown, so as to be capable of scanning along the first surface 40a of the base substrate wafer 40 in the opposite direction. The glass frit 38 used in this embodiment is paste material mainly containing powdered glass particles and binder including organic solvent and ethyl cellulose blended therein.

When starting the filling step (S35), the base substrate wafer 40 is set to the jig, not shown, of the vacuum printing apparatus in a state in which the first surface 40a (the large diameter side of the through holes 21 and 22) is faced upward, and a metal mask, not shown, is arranged on the first surface 40a of the base substrate wafer 40. The metal mask is a mask for preventing wraparound of the glass frit 38 to the second surface 40b of the base substrate wafer 40, which covers the peripheral edge portion of the base substrate wafer 40 and is formed with an opening at a center portion thereof. Subsequently, the evacuation of the chamber of the vacuum printing apparatus is performed to generate a decompressed atmosphere (for example, approximately 0.5 to 1 torr) in the camber.

Then, the glass frit 38 is supplied on the metal mask on the near side of the first squeegee 45 in the scanning direction. Subsequently, in a state in which a distal end of the first squeegee 45 is in abutment with the metal mask (the first surface 40a of the base substrate wafer 40), the first squeegee 45 is scanned along the first surface 40a of the base substrate wafer 40 (a first scanning step (S35A)). In this case, the first squeegee 45 is scanned from one end side to the other end side in the radial direction of the base substrate wafer 40 (see an arrow in FIG. 9A) so that the first surface 40a of the base substrate wafer 40 and the scanning surface of the first squeegee 45 are aligned in parallel to each other.

When the first squeegee 45 is scanned, the glass frit 38 is flowed so as to be swept away along the direction of scanning of the first squeegee 45 by the distal end of the first squeegee 45. Accordingly, the glass fit 38 is even out along the upper surface of the base substrate wafer 40. When scanning the first squeegee 45 along opening edges of the through holes 21 and 22, the glass frit 38 in the vicinity of the opening edge flows as if it is swept away into the through holes 21 and 22 by the distal end of the first squeegee 45. Consequently, the glass frit 38 is filled into the through holes 21 and 22 (see FIG. 9B).

In this case, by performing the filling step (S35) in this embodiment using a vacuum printing method, the glass frit 38 is degassed, and hence the air bubbles (air or the like) contained in the glass frit 38 can be removed. Accordingly, the glass frit 38 containing less air bubbles can be filled in the through holes 21 and 22.

Since the glass frit 38 is filled in a state in which the interiors of the through holes 21 and 22 are degassed, the through holes 21 and 22 can be filled smoothly with the glass frit 38 in comparison with the case of filling the glass frit 38 in an atmosphere under an atmospheric pressure. Consequently, the through holes 21 and 22 can be filled with the glass frit 38 without forming a gap. In addition, in this embodiment, by filling the through holes 21 and 22 with the glass frit 38 from the large diameter side, the gaps between the through holes 21 and 22 and the metallic pins 37 can be filled with the glass frit 38 easily.

After having ended the first scanning step (S35A), a second scanning step (S35B) for removing the excessive glass frit 38 remaining on the first surface 40a of the base substrate wafer 40 is performed. More specifically, as shown in FIG. 9C, the second squeegee 46 is scanned along the direction opposite from the direction of scanning of the first squeegee 45 (for example, from the other end side to one end side in the radial direction of the base substrate wafer 40) under the similar conditions as the conditions of scanning the first squeegee 45 described above in a state in which a distal end of the second squeegee 46 is kept in contact with the first surface 40a of the base substrate wafer 40 (see an arrow in FIG. 9C). Accordingly, as shown in FIG. 9D, the glass frit 38 present on the outside of the through holes 21 and 22 (on the first surface 40a of the base substrate wafer 40) can be removed. In this embodiment, since the length of the core member 31 of the metallic pin 37 is reduced to be shorter than the thickness of the base substrate wafer 40, contact between the distal end of the second squeegee 46 and the distal end of the core member 31 when the second squeegee 46 passes over the through holes 21 and 22 is avoided, so that the core member 31 can be restrained from being inclined.

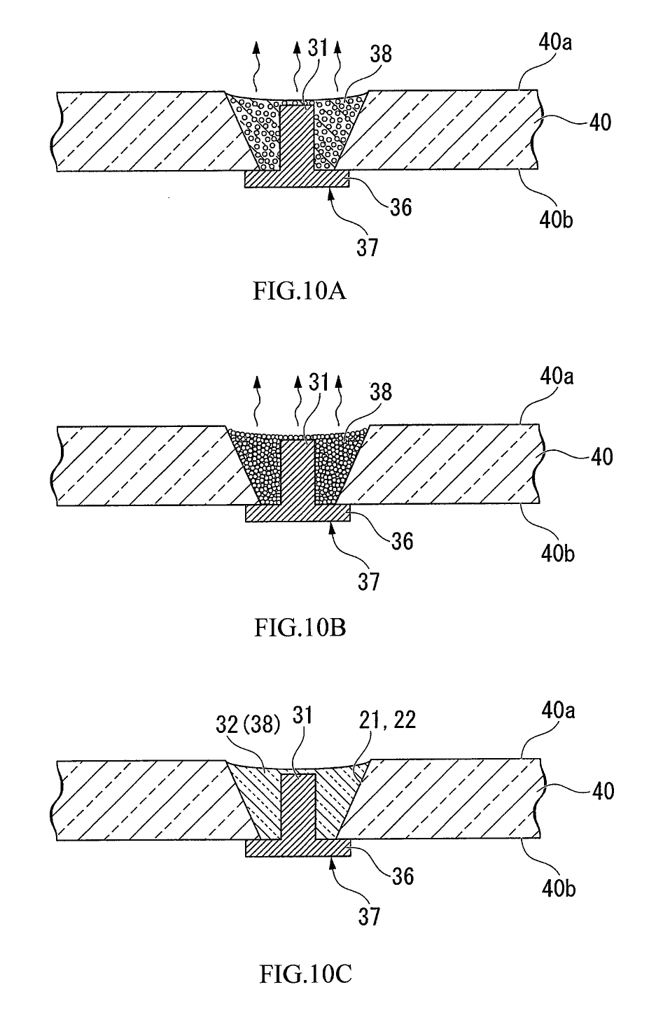

FIGS. 10A to 10C are cross-sectional views of the base substrate wafer and are process drawings for explaining steps from a provisionally drying step onward.

Subsequently, as shown in FIG. 10A, the glass frit 38 embedded in the filling step (S35) is provisionally dried (S36) (the provisionally drying step). More specifically, the base substrate wafer 40 filled with the glass frit 38 is transported into a drying furnace. Then, the temperature in the drying furnace is maintained at approximately 80° C., for example, in the atmosphere under an atmospheric pressure to dry the base substrate wafer 40 for approximately 30 minutes.

The boiling point of the organic solvent blended in the glass frit 38 is lower than 80° C. Therefore, in the provisionally drying step (S36), the organic solvent blended in the glass frit 38 is evaporated and removed. In contrast, the melting point of the glass particles contained in the glass frit 38 is generally approximately 500° C. to 600° C., and is considerably higher than 80° C., which is a temperature of the provisionally drying step (S36). Therefore, in the provisionally drying step (S36), the glass frit 38 does not melt. The boiling point of the binder (ethyl cellulose) blended in the glass frit 38 is approximately 350° C., which is considerably higher than the temperature in the provisionally drying step (S36). Therefore, in the provisionally drying step (S36), the binder does not evaporate.

As described above, at this time point, the glass particles in the glass frit 38 are not melted, and hence the voids are present among the glass particles. Therefore, gas generated by evaporation of the organic solvent flows in the voids among the glass particles and is discharged out from the glass frit 38 (see arrows in FIG. 10A). Therefore, since the organic solvent can be removed effectively before a baking step (S38), such gas to be generated by evaporation of the organic solvent in the baking step (S38) can be restrained.

Subsequently, as shown in FIG. 10B, a binder removing step (S37) for removing the binder contained in the glass frit 38 is performed. More specifically, the base substrate wafer 40 after having ended the provisionally drying step (S36) is transferred into a chamber in a heating furnace, and the temperature in the heating furnace is kept at approximately 420° C. in an atmosphere under the atmospheric air to heat the base substrate wafer 40 for approximately one hour. In this manner, by setting the temperature in the heating furnace to a temperature higher than the boiling point of the binder and lower than the melting point of the glass particles in the binder removing step (S37), the binder can be evaporated without melting the glass particles. Accordingly, the gas generated by evaporation of the binder flows in the voids among the glass particles and is discharged efficiently out of the glass frit 38 (see arrows in FIG. 10B). Since the binder can be removed effectively before the baking step (S38), the gas to be generated by evaporation of the binder in the baking step (S38) can be restrained.

Then, finally, the base substrate wafer 40 after having ended the binder removing step (S37) is transferred into the chamber of the baking furnace, and the baking step (S38) for forming the cylindrical member 32 (see FIG. 3) by baking the glass particles contained in the glass frit 38 is performed.

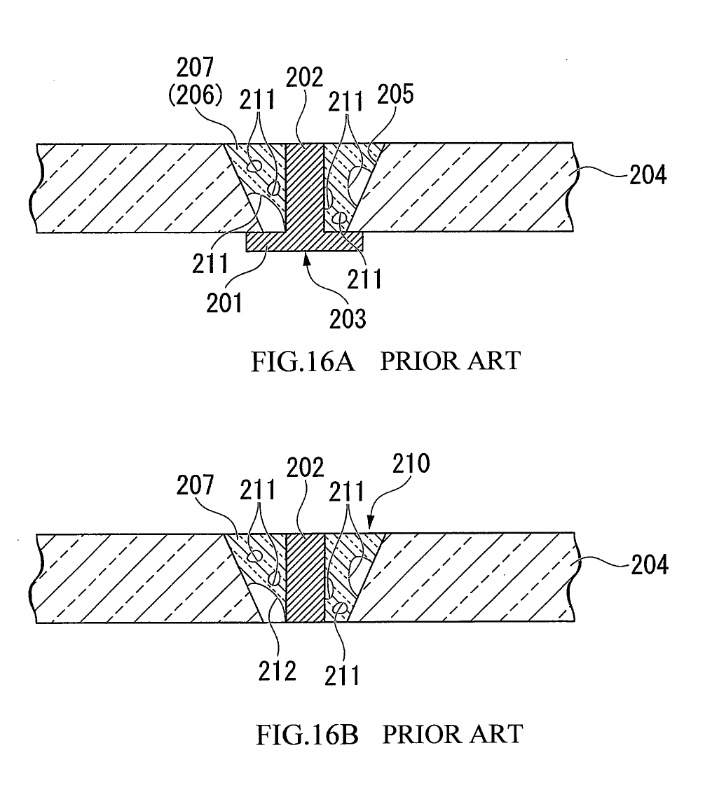

Incidentally, there is a case where the binder which could not be removed in the binder removing step (S37) and air contained among the glass particles is remained therein in the glass frit 38 at the time of the baking step (S38). In this case, by performing the baking step (S38), a glass frit 206 on the outside after the completion of baking acts as a lid as shown in FIG. 16A described above, gas generated by evaporation of binder in the glass frit 206 or air or the like entrapped among glass particles in the glass frit 206 are not discharged to the outside of the glass frit 206, and remains disadvantageously as voids 211 in the glass frit 206.

Therefore, as shown in FIG. 10C, in the baking step (S38) in this embodiment, decompressed baking for baking the glass frit 38 is performed in a state in which the interior of the baking furnace is decompressed is performed. More specifically, in a state in which the interior of the baking furnace is decompressed, for example, a temperature atmosphere at approximately 610° C. is maintained. At this time, the pressure in the baking furnace is preferably set to a pressure lower than the atmospheric pressure and, in this embodiment, for example, is maintained to approximately 1 to 10 torr. Consequently, baking of the glass frit 38 is performed while the air bubbles remaining in the glass frit 38 are removed. Then, after having baked the glass frit 38 for approximately 30 minutes in this state, the base substrate wafer 40 is set aside standstill and cooled under a normal temperature atmosphere. Accordingly, the glass frit 38 is solidified and is formed into the cylindrical member 32, and the cylindrical member 32, the core member 31, and the through holes 21 and 22 are secured to each other to form the above-described through electrodes 8 and 9. In this case, by performing the vacuum baking on the glass frit 38 as in this embodiment, formation of the voids (for example, the voids 211 in FIG. 16) in the cylindrical member 32 after the baking can be restrained.

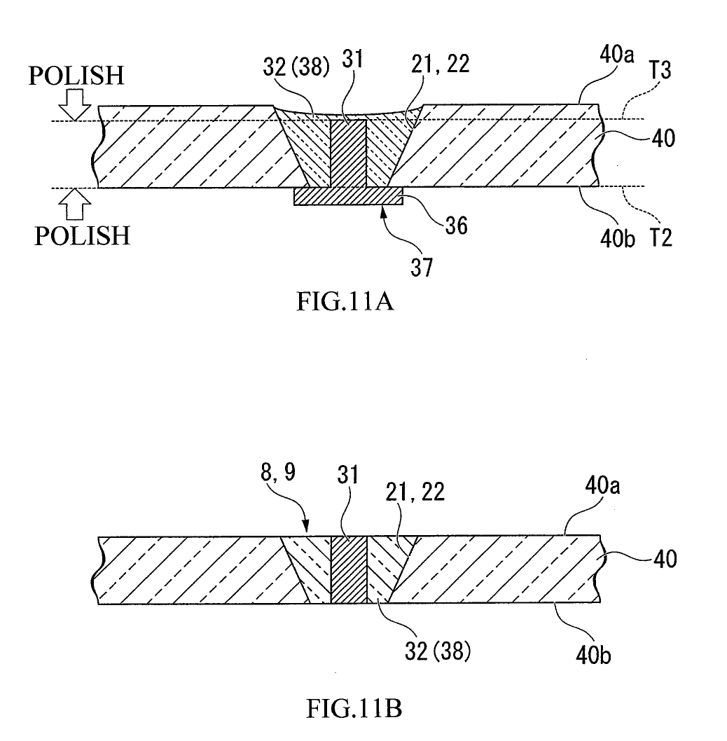

FIGS. 11A and 11B are cross-sectional views of the base substrate wafer and serve as process drawings for explaining a grinding step. Subsequently, as shown in FIG. 11A, the grinding step (S38) for grinding the base substrate wafer 40 on the side of the second surface 40b to a broken line T2 after the baking and removing the base member 36 of the metallic pin 37 is performed. Accordingly, the base member 36 which has been working to position the cylindrical member 32 and the core member 31 can be removed, and hence only the core member 31 can be left in the interior of the cylindrical member 32.

Simultaneously, the first surface 40a of the base substrate wafer 40 is ground to a broken line T3 to expose the distal end of the core member 31. Consequently, the plurality of pairs of the through electrodes 8 and 9 in which the cylindrical member 32 and the core member 31 are integrally fixed can be obtained.

Subsequently, patterning of the conductive material is performed on the second surface 40b of the base substrate wafer 40, so that a drawing electrode forming step (S39) is performed. In this manner, the base substrate wafer fabricating step (S30) is ended.

### (Assembling Step)

Subsequently, the respective piezoelectric vibration reeds 5 fabricated in the piezoelectric vibration reed fabricating step (S10) are mounted on the respective drawing electrodes 27 and 28 of the base substrate wafer 40 fabricated in the base substrate wafer fabricating step (S30) via the bumps B such as gold (S40). Then, a superimposing step for superimposing the base substrate wafer 40 and the lid substrate wafer 50 fabricated in the fabricating step (S50) for the above-described respective wafers 40 and 50 is performed. More specifically, the both wafers 40 and 50 are aligned at a proper position with reference to a reference mark or the like, not shown. Accordingly, a state in which the mounted piezoelectric vibration reeds 5 are stored in the cavities C surrounded by the depressed portions 3a formed on the lid substrate wafer 50 and the base substrate wafer 40 is achieved.

After having the superimposing step (S50), the two superimposed wafers 40 and 50 are put in an anodic wafer bonding apparatus, not shown, and a bonding step (S60) for applying a predetermined voltage in an atmosphere at a predetermined temperature to bond the wafers 40 and 50 by anodic wafer bonding in a state of clamping an outer peripheral portion of the wafers by a holding mechanism, not shown, is performed. More specifically, a predetermined voltage is applied between the bonding material 23 and the lid substrate wafer 50. Then, an electrochemical reaction occurs in an interface between the bonding material 23 and the lid substrate wafer 50, and the both are tightly adhered to each other and bonded by anodic wafer bonding. Accordingly, the piezoelectric vibration reed 5 can be sealed in the cavity C, and the bonded wafer member 60 including the base substrate wafer 40 and the lid substrate wafer 50 bonded to each other can be obtained. Then, as in this embodiment, by bonding the both wafers 40 and 50 with each other by anodic wafer bonding, displacement due to aged deterioration, an impact, or the like and warping of the bonded wafer member 60 are prevented and the both wafers 40 and 50 can be further firmly bonded to each other in comparison with a case in which the both wafers 40 and 50 are bonded with an adhesive agent or the like.

Subsequently, pairs of external electrodes 6 and 7 electrically connected respectively to the pairs of through electrodes 8 and 9 are formed (S70), and the frequency of the piezoelectric vibrators 1 is fine-adjusted (S80). Then, a cutting step (S90) for cutting the bonded wafer member 60 into pieces along the cutting lines M is performed.

In an electric characteristic inspecting step (S100), the resonance frequency or the resonance resistance, and drive level characteristics (exciting power dependency of the resonance frequency and the resonance resistance) of the piezoelectric vibrator 1 are measured and checked. The insulative resistance characteristics are also checked. Finally, an appearance inspection of the piezoelectric vibrators 1 is performed to finally check the size and quality.

With the procedure as described above, the piezoelectric vibrator 1 is completed.

In this manner, according to the embodiment, the glass frit 38 is baked in a decompressed atmosphere, which is set to be lower than the atmospheric pressure in the baking step (S38).

In this configuration, since the glass fit 38 can be baked while degassing, the air bubbles, if they are remained in the glass frit 38, can be removed at the time of baking. Accordingly, formation of the voids 211 (see FIG. 16) in the cylindrical members 32 after the baking is restrained, and the solid cylindrical members 32 can be formed between the through holes 21 and 22 and the metallic pins 37. Therefore, hermeticity in the cavities C can be maintained by improving adhesion of the through holes 21 and 22 and the metallic pins 37 with respect to the cylindrical members 32. Also, formation of a depression or the like in the cylindrical member 32 is restrained, and occurrence of breakage of electrode films (for example, the external electrodes 7 and 8 or the drawing electrodes 27 and 28) formed so as to cover the through electrodes 8 and 9 is restrained, and conductivity between the inside and the outside of the cavities C can be secured.

Also, since the adhesion of the through holes 21 and 22 and the metallic pins 37 with respect to the cylindrical member 32 can be improved, the mechanical strength of the through electrodes 8 and 9 can be improved. Consequently, the mechanical strength of the piezoelectric vibrator 1 can be secured.

In this embodiment, the through holes 21 and 22 can be filled with the glass frit 38 having less air bubbles without the gap as described above by performing the filling step (S35) under the decompressed atmosphere. Then, by baking the glass frit 38 in this state, the through holes 21 and 22 can be sealed without the gap by the cylindrical member 32, the adhesion between the through holes 21 and 22 and the metallic pin 37 with respect to the cylindrical member 32 is improved, and the maintenance of the hermeticity in the cavity C and the mechanical strength of the through electrodes 8 and 9 can be improved.

Since the cost of baking furnace (vacuum baking) used in the decompressed baking is less expensive as an apparatus (baking furnace) in comparison with the baking furnace for compression baking for baking at a higher pressure than the atmospheric pressure for example, reduction of the manufacturing cost is also achieved.

In this manner, since the package 10 superior in hermeticity can be provided, the piezoelectric vibrator 1 superior in vibrating properties can be provided. The piezoelectric vibrator 1 superior in conductivity between the inside and the outside of the cavity C can also be provided. In addition, the piezoelectric vibrator 1 secured in the mechanical strength can be provided.

### (Oscillator)

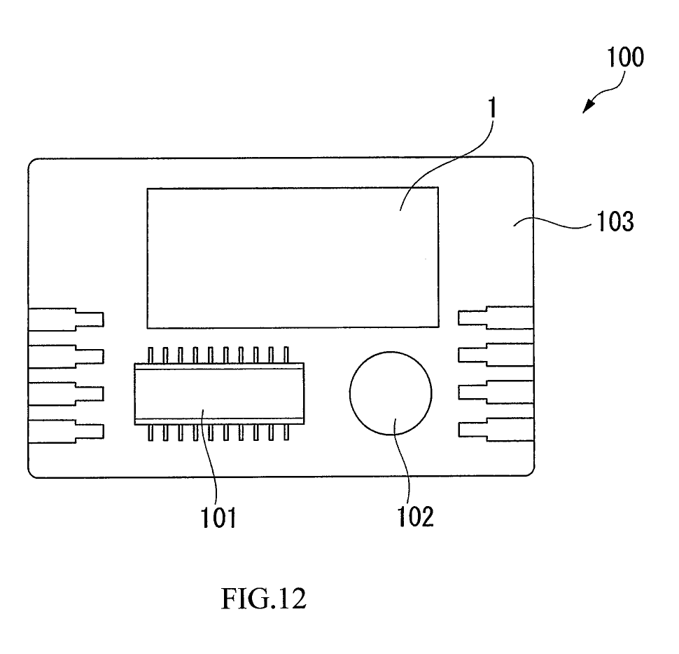

Subsequently, an embodiment of an oscillator according to the invention will be described with reference to FIG. 12.

An oscillator 100 in this embodiment includes the piezoelectric vibrator 1 as an oscillation element electrically connected to an integrated circuit 101 as shown in FIG. 12. The oscillator 100 includes a substrate 103 on which an electronic component 102 such as a capacitor is mounted. The integrated circuit 101 as described above for the oscillator is mounted on the substrate 103, and the piezoelectric vibration reed 5 of the piezoelectric vibrator 1 is mounted in the vicinity of the integrated circuit 101. The electronic component 102, the integrated circuit 101, and the piezoelectric vibrator 1 are electrically connected to each other with a wring pattern, not shown. The respective components are molded by resin, not shown.

In the oscillator 100 configured as described above, when a voltage is applied to the piezoelectric vibrator 1, the piezoelectric vibration reed 5 in the piezoelectric vibrator 1 vibrates. This vibration is converted into an electric signal by the piezoelectric characteristic of the piezoelectric oscillation reed 5 and is inputted to the integrated circuit 101 as the electric signal. The inputted electric signal is subjected to various sorts of processing by the integrated circuit 101, and is outputted as a frequency signal. Accordingly, the piezoelectric vibrator 1 functions as the oscillation element.

Also, by selectively setting the configuration of the integrated circuit 101, for example, an RTC (real time clock) module or the like according to the requirement, not only a function as a single function oscillator for a clock, but also a function to control the date or the time instant of operation of the corresponding apparatus or an external apparatus or to provide the time instant or a calendar or the like of the same may be added.

As described above, according to the oscillator 100 in this embodiment, since the piezoelectric vibrator 1 described above is provided, the oscillator 100 superior in characteristics and reliability can be provided. In addition, stable and highly accurate frequency signals can be obtained over a long time.

### (Electronic Apparatus)

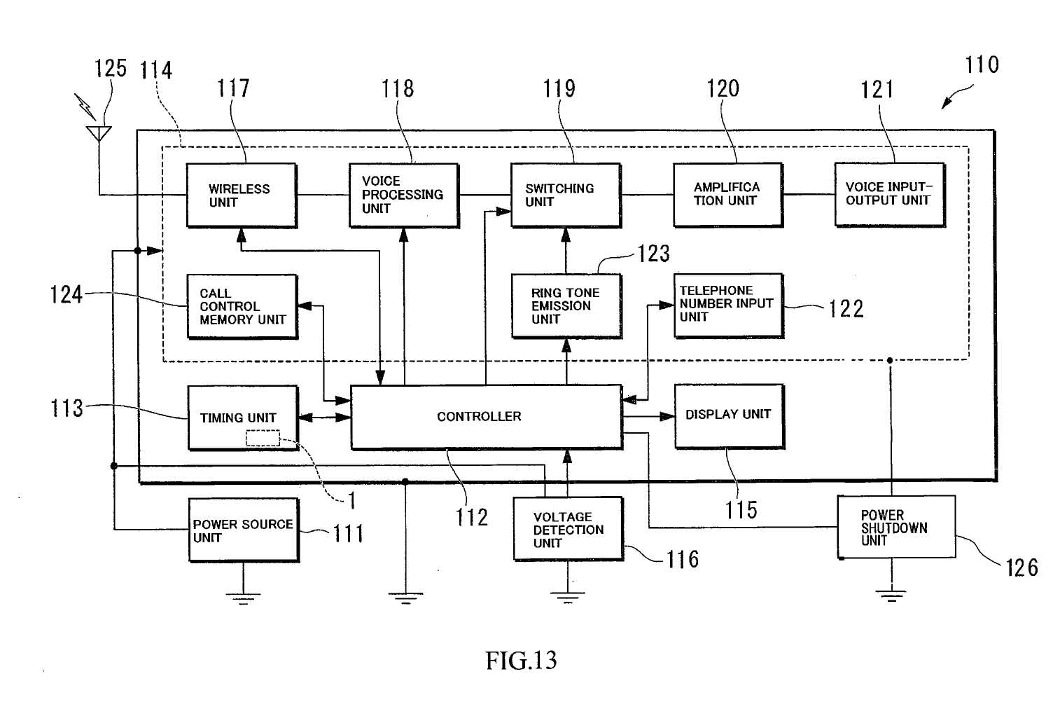

Subsequently, an embodiment of an electronic apparatus according to the invention will be described with reference to FIG. 13. As the electronic apparatus, a portable digital assistant device 110 having the piezoelectric vibrator 1 described above will be exemplified for description. First of all, the portable digital assistant device 110 in this embodiment is represented, for example, by a mobile phone set, and is development and improvement of a wrist watch in the related art. The appearance is similar to the wrist watch, and a liquid crystal display is arranged on a portion corresponding to a dial, so that the current time instance or the like can be displayed on a screen thereof. When using as a communication instrument, it is removed from the wrist, and communication as achieved by the mobile phone set in the related art can be performed with a speaker and a microphone built in an inner portion of a band. However, downsizing and weight reduction are achieved significantly in comparison with the mobile phone set in the related art.

### (Portable Digital Assistant Device)

Subsequently, a configuration of the portable digital assistant device 110 according to the second embodiment will be described. The portable digital assistant device 110 includes the piezoelectric vibrator 1 and a power source unit 111 for supplying electric power as shown in FIG. 13. The power source unit 111 is composed, for example, of a lithium secondary battery. Connected in parallel to the power source unit 111 are a control unit 112 configured to perform various controls, a clocking unit 113 configured to perform clocking of time of the day or the like, a communication unit 114 configured to perform communication with the outside, a display unit 115 configured to display various items of information, and a voltage detection unit 116 configured to detect the voltages of the respective functioning portions. The power source unit 111 is configured to supply electric power to the respective functioning portions.

The control unit 112 controls the respective functioning portions to perform action control of an entire system such as sending and receiving of voice data, or measurement or display of the current time instance. Also, the control unit 112 includes a ROM in which a program is written in advance, a CPU configured to read and execute the program written in the ROM, and a RAM used as a work area of the CPU.

The clocking unit 113 includes an integrated circuit having an oscillating circuit, a register circuit, a counter circuit, and an interface circuit integrated therein, and the piezoelectric vibrator 1. When a voltage is applied to the piezoelectric vibrator 1, the piezoelectric oscillation reed 5 vibrates, and this vibration is converted into an electric signal by a piezoelectric characteristic of crystal and is inputted to the oscillating circuit as the electric signal. The output from the oscillating circuit is binarized, and is counted by the register circuit and the counter circuit. Then, sending and receiving of the signal with respect to the control unit 112 is performed via the interface circuit, and the current time instance, the current date, the calendar information, or the like are displayed on the display unit 115.

The communication unit 114 has the same function as the mobile phone set in the related art, and includes a wireless unit 117, a voice processing unit 118, a switching unit 119, an amplifying unit 120, a voice input and output unit 121, a telephone number input unit 122, an incoming call ring tone generating unit 123, and a calling control memory unit 124.

The wireless unit 117 sends and receives various data such as the voice data with respect to a base station via an antenna 125. The voice processing unit 118 codes and decodes the voice signal inputted from the wireless unit 117 or the amplifying unit 120. The amplifying unit 120 amplifies the signal inputted from the voice processing unit 118 or the voice input and output unit 121 to a predetermined level. The voice input and output unit 121 includes a speaker and a microphone, and reinforces an incoming call ring tone or a receiving voice, or collects the voice.

Also, the incoming call ring tone generating unit 123 generates the incoming call ring tone according to the call from the base station. The switching unit 119 switches the amplifying unit 120 connected to the voice processing unit 118 to the incoming call ring tone generating unit 123 only at the time of the incoming call, so that the incoming call ring tone generated by the incoming call ring tone generating unit 123 is outputted to the voice input and output unit 121 via the amplifying unit 120.

The calling control memory unit 124 stores the program relating to communication dialing and incoming ring tone control. Also, the telephone number input unit 122 includes, for example, numeral keys from 0 to 9 and other keys, and a telephone number of a call target is entered by pressing these numeral keys and the like.

The voltage detecting unit 116 detects a voltage drop when the voltage applied to the respective functioning portions such as the control unit 112 by the power source unit 111 falls below the predetermined value, and notifies it to the control unit 112. The predetermined voltage at this time is a value preset as a minimum voltage for stably operating the communication unit 114 and, for example, is on the order of 3V. The control unit 112, upon reception of the notification about the voltage drop from the voltage detecting unit 116, restricts the operations of the wireless unit 117, the voice processing unit 118, the switching unit 119, and the incoming call ring tone generating unit 123. In particular, the stop of the operation of the wireless unit 117 which consumes a large amount of power is essential. Furthermore, the fact that the communication unit 114 is disabled due to the short of the remaining amount of battery is displayed on the display unit 115.

In other words, the operation of the communication unit 114 may be restricted by the voltage detecting unit 116 and the control unit 112, and this may be displayed on the display unit 115. This display may be a text message, but may be a cross mark on a telephone icon displayed on an upper portion of the display surface of the display unit 115 as a further intuitive display.

By providing a power source blocking unit 126 which is capable of selectively disconnect the power source of a portion relating to the function of the communication unit 114, the function of the communication unit 114 can be stopped further reliably.

As described above, according to the portable digital assistant device 110 in this embodiment, since the piezoelectric vibrator 1 described above is provided, the portable digital assistant device 110 superior in characteristics and reliability can be provided. In addition, a stable and highly accurate time information can be displayed over a long time.

(Radio timepiece)

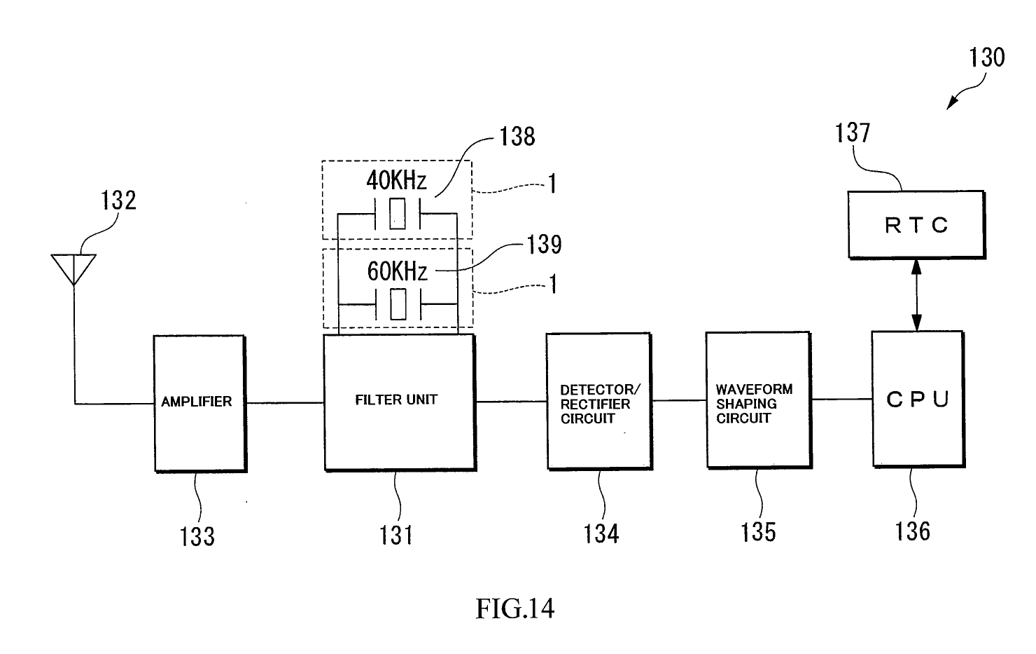

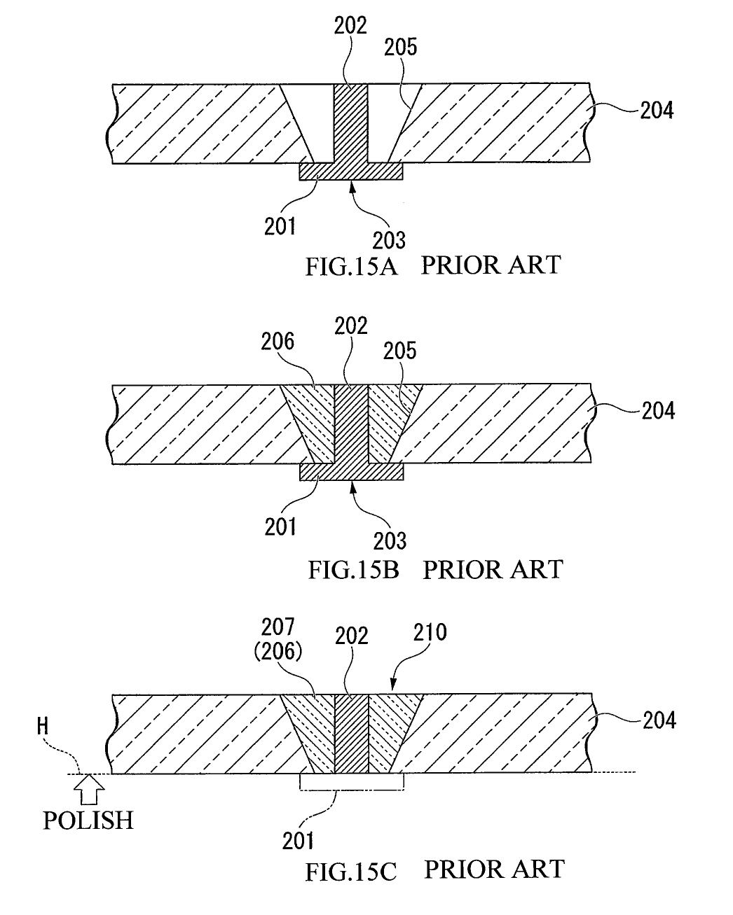

Subsequently, an embodiment of a radio timepiece according to the invention will be described with reference to FIG. 14.

A radio timepiece 130 includes the piezoelectric vibrator 1 electrically connected to a filtering unit 131 as shown in FIG. 14, and is a clock having functions to receive a standard radio wave including a clock data, correct automatically the same to an accurate time instance and display the same.

In Japan, transmitter points (transmitter stations) which transmit the standard radio wave in Fukushima-ken (40 kHz) and Saga-ken (60 kHz), and these stations transmit the standard radio waves respectively. Long radio waves such as 40 kHz or 60 kHz have both a feature to propagate on the ground surface and a feature to propagate while being reflected between the ionosphere and the ground surface, so that it has a large propagation range, and hence Japan is entirely covered by the above-described two transmitter stations.

A functional configuration of the radio timepiece 130 will be described in detail below.

The antenna 132 receives a long standard radio wave of 40 kHz or 60 kHz. The long standard radio wave is generated by AM modulating the hour instance data referred to as a time code into a carrier wave of 40 kHz or 60 kHz. The received long standard radio wave is amplified by an amplifier 133 and filtered and synchronized by the filtering unit 131 having the plurality of piezoelectric vibrators 1.

The piezoelectric vibrators 1 in this embodiment each include quartz vibrator units 138 and 139 having a resonance frequency of 40 kHz and 60 kHz which is the same as the above-described carrier frequency.

Furthermore, the filtered signal having the predetermined frequency is detected and demodulated by a detecting and rectifying circuit 134. Subsequently, the time code is acquired via a waveform shaping circuit 135, and is counted by a CPU 136. In the CPU 136, data such as the current year, the total day, the day of the week, the time instance is read. The read data is reflected on the RTC 137, and the accurate time instance data is displayed.

Since the carrier wave is of 40 kHz or 60 kHz, the quartz vibrator units 138 and 139 are preferably vibrators having the tuning fork type structure described above.

The description given above is about the example in Japan and the frequency of the long standard radio wave is different in other countries. For example, in Germany, a standard wave of 77.5 KHz is used. Therefore, when integrating the radio timepiece 130 for overseas use into portable equipment, the piezoelectric vibrator 1 having a different frequency from Japan is necessary.

As described above, according to the radio timepiece 130 in this embodiment, since the piezoelectric vibrator 1 described above can be provided, the radio timepiece 130 superior in characteristics and reliability is provided. In addition, stable and highly accurate time count is achieved over a long time.

The technical scope of the invention is not limited to the embodiments shown above, and various modifications may be made without departing the scope of the invention.

For example, in the embodiment described above, the piezoelectric vibrator is manufactured by sealing the piezoelectric vibration reed in the interior of the package while using the method of manufacturing the package according to the invention. However, it is also possible to manufacture a device other than the piezoelectric vibrator by sealing an electronic component other than the piezoelectric vibration reed in the interior of the package.

In the embodiment described above, the method of manufacturing the package according to the invention has been described with an example of the piezoelectric vibrator using the tuning fork-shaped piezoelectric vibration reed. However, the invention is not limited thereto, and the invention may be applied to, for example, the piezoelectric vibrator using an AT cut-shaped piezoelectric vibration reed (a thickness-shear vibration reed).

In the embodiment described above, a case of forming the through electrodes 7 and 8 by arranging the metallic pins 37 extending upright from the base members 36 in the through holes 21 and 22, and then grinding and removing the base members 36 has been described. However, the invention is not limited thereto. For example, a configuration in which the through holes 21 and 22 are formed into a bottomed depressed portion, and the column-shaped metallic pin is arranged in the depressed portion to form the through electrode is also applicable. However, this embodiment is superior in possibility of arrangement in the through hole without causing inclination of the metallic pin.

In the embodiment described above, a case in which the pressure in the baking furnace is set to 1 to 10 torr has been described in the baking step (S38). However, the pressure may be adjusted as needed as long as it is lower than the atmospheric pressure.

In the embodiment described above, a configuration in which the provisionally drying step (S36) and the binder removing step (S37) is performed in the atmosphere of the atmospheric pressure has been described. However, the invention is not limited thereto, and the provisionally drying step (S36) and the binder removing step (S37) may be performed in the decompressed atmosphere.

What is claimed is:

1. A method for producing electronic packages, comprising:
(a) defining a plurality of first substrates on a first wafer and a plurality of second substrates on a second wafer;
(b) forming at least one through-hole in a respective at least some of the first substrates on the first wafer;
(c) filling at least some of the through-holes with a filler which comprises glass frit;
(d) baking the first wafer to harden the filler, wherein at least one of steps (c) and (d) is performed in a low pressure atmosphere;
(e) bonding the first and second wafers such that at least some of the first substrates substantially coincide respectively with at least some of the corresponding second substrates; and
(f) cutting off from the bonded first and second wafers a respective at least some of the coinciding first and second substrate pairs.

2. The method according to claim 1, wherein the filler comprises a binder and an organic solvent.

3. The method according to claim 2, wherein the binder comprises ethyl cellulose.

4. The method according to claim 1, wherein filling at least some of the through-holes with a filler comprises squeegeeing the filler twice in substantially opposite directions in the at least some of the through-holes.

5. The method according to claim 4, wherein filling at least some of the through-holes comprises filling at least some of the through-holes at a pressure of about 0.5 to 1 torr.

6. The method according to claim 2, further comprising, between steps (c) and (d), drying the filler at a temperature lower than a boiling point of the binder and higher than a boiling point of the organic solvent.

7. The method according to claim 6, wherein drying the filler comprises heating the filler at about 80° C. for about 30 minutes.

8. The method according to claim 6, further comprising, between steps (c) and (d) after drying the filler, removing the binder from the filler at a temperature lower than a melting point of the glass frit and higher than the boiling point of the binder.

9. The method according to claim 8, wherein removing the binder comprises heating the filler at about 420° C. for about one hour.

10. The method according to claim 1, wherein baking the first wafer comprises heating the first wafer at a temperature of about 610° C. for about 30 minutes at a pressure of about 1 to 10 torr.

11. The method according to claim 1, further comprising, between steps (b) and (c), inserting a conductive pillar in a respective at least some of the through-holes.

12. The method according to claim 11, further comprising, between steps (d) and (e), removing at least one main surface of the first wafer to expose both ends of the conductive pillars from main surfaces of the first wafer.

13. The method according to claim 1, wherein step (c) comprises, before bonding the first and second wafers, placing a piezoelectric vibrating reed in a respective at least some of coinciding first and second substrates.

14. The method according to claim 13, wherein the electronic package is a piezoelectric vibrator.

15. A method for producing an electronic package, comprising:
(a) forming at least one through-hole in a substrate of the electronic package;
(b) filling the at least one through-hole with a filler which comprises glass frit, binder and an organic solvent; and
(c) baking the substrate to harden the filler, wherein at least one of steps (b) and (c) is performed in a low pressure atmosphere.

16. The method according to claim 15, wherein the binder comprises ethyl cellulose.

17. The method according to claim 15, wherein filling the at least one through-hole with a filler comprises filling the at least one e of the through-hole with a filler at a pressure of about 0.5 to 1 torr.

18. The method according to claim 15, further comprising, between steps (b) and (c), drying the filler at a temperature lower than a boiling point of the binder and higher than a boiling point of the organic solvent.

19. The method according to claim 18, wherein drying the filler comprises heating the filler at about 80° C. for about 30 minutes.

20. The method according to claim 18, further comprising, between steps (b) and (c) after drying the filler, removing the binder from the filler at a temperature lower than a melting point of the glass frit and higher than the boiling point of the binder.

21. The method according to claim 20, wherein removing the binder comprises heating the filler at about 420° C. for about one hour.

22. The method according to claim 15, wherein baking the substrate comprises heating the substrate at a temperature of about 610° C. for about 30 minutes at a pressure of about 1 to 10 torr.
